(19) United States
(12) Patent Application Publication
(10) Pub. No.: US 2003/0208944 A1
(43) Pub. Date: Nov. 13, 2003

(54) Dynamic wind powered decoy

(76) Inventors: Todd J. Olson, New Ulm, MN (US); Kent L. Blomquist, New Ulm, MN (US)

Correspondence Address: Roger W. Jensen, Roger W. Jensen & Associates, Ltd., 8127 Pennsylvania Circle, Minneapolis, MN, 55438, US

(21) Appl. No.: 10/434,514

(22) Filed: May 8, 2003

Related U.S. Application Data
(60) Provisional application No. 60/378,865, filed on May 9, 2002.

(51) Int. Cl. A01M 31/06

(52) U.S. Cl. 43/3

(57) ABSTRACT

A dynamic, wind powered decoy having a body member (with a longitudinal axis), rod means connected to the body member and extending longitudinally away from the body member, and a wing assembly rotatably mounted on the rod means. The decoy has pivot means in the body member defining a pivot axis at a selected angle from the longitudinal axis. When the decoy is pivotally supported, the wing assembly rotates about the longitudinal axis and the decoy rotates about the pivot axis to a heading whereat the body member is headed into the wind.

This application is based on our Provisional U.S. Patent Application filed May 9, 2002, Serial No. 60/378,865.

### BACKGROUND OF THE INVENTION

This invention relates to the field of decoys for attracting game birds to approach a preselected location, this field in broad terms being one that is very old. For example, hunters of ducks and other waterfowl, have long used static (non-dynamic) decoys to try to attract the waterfowl to fly (or in some cases alight in the water) close enough to the hunters to provide an opportunity for the hunters to try to shoot the waterfowl. A typical duck-hunting scenario is for the hunters to have a hunting blind adjacent to a body of water. The hunters will deploy a plurality of static-type decoys in the water, use the blind for some measure of concealment, and hope for good results.

Although static-type decoys can sometimes yield reasonable results, they are problematic. A key limitation of static-type decoys is that they frequently fail to attract the sought after game.

There have been some prior art dynamic-type decoys all of which are problematic. For example, one prior art dynamic-type decoy comprises a body within which is electric motor means (arid a battery) connected to rotate a pair of side mounted wings about an axis transverse to the body's longitudinal axis. This decoy has major disadvantages, e.g., the decoy is heavy, expensive, bulky, does not head into the wind, and is prone to electrical/mechanical malfunctioning including frequent replacement of the batteries.

### SUMMARY OF THE INVENTION

The present invention is a wind powered dynamic decoy which is free from the aforesaid disadvantages and further has, because of its unique physical features, a number of important advantages absent from prior art decoys.

In broad terms, the present invention provides a decoy comprising a body member having a longitudinal axis, rod means connected to the body member and extending longitudinally away from the body member, and a wing assembly rotatably mounted on the rod means for rotation about the longitudinal axis.

The body member includes pivot means defining a pivot axis at a preselected angle with respect to the longitudinal axis. The decoy is adapted to be supported by a post, or the like, co-acting with the pivot means so that, when there is a wind of preselected velocity or greater, there are two dynamic actions. First, the wing assembly rotates about the rod means. Second, the entire decoy rotates about the pivot axis to a heading where the wind direction vector and the longitudinal axis are co-planar, i.e., the forward end of the decoy faces into the wind. These two dynamic actions are very advantageous and are somewhat interconnected. The combination of the decoy headed into the wind with the wing assembly rotating is visually (to a duck or other waterfowl) a rather faithful and authentic representation of a duck or other waterfowl, as the case may be, either landing into a spread or set of waterfowl or taking flight from the said spread or set.

The wing assembly is aerodynamically efficient. Thus, the wind-powered decoy is self-starting, with the slightest breeze; the decoy follows the wind and the wing assembly rotates about the rod means. The unique wing motion and preferred contrasting element coloration design attracts waterfowl from long distances. The decoy is extremely durable in strong winds and in cold temperatures. Also, the decoy increases the effectiveness of a spread or set of decoys. The collapsible design facilitates easy set up, take down and transportation.

### DESCRIPTION OF THE DRAWINGS

FIG. 1 is a right side view of a wind powered dynamic decoy, the preferred embodiment of our invention;

FIG. 2 is a plan view of a wing assembly element for the decoy of FIG. 1;

FIG. 3 is a plan view of a plurality of the elements of FIG. 2 assembled in side-by-side and congruent relationship and rotatably connected by grommet-like means also shown in FIG. 4;

FIG. 4 is a cross-section of the assembled elements for the wing assembly as viewed along section lines 4-4 of FIG. 3;

FIG. 5 is an isometric front, right-side view of the wing assembly for the decoy of FIG. 1;

FIG. 6 is a partial view of the aft end of the wing assembly, mounted for rotation on rod means, showing retainer means for retaining the wing assembly on the rod means;

FIG. 7 is a side, cross-section of a body member with integral rod means (partially shown) for the decoy of FIG. 1, this figure also depicting a support means for co-acting with pivot means in the body member;

FIG. 8 is a cross section of the support means as viewed along section lines 8-8 of FIG. 7; and

FIG. 9 is a right side view of another embodiment of our invention.

### DETAILED DESCRIPTION OF THE INVENTION

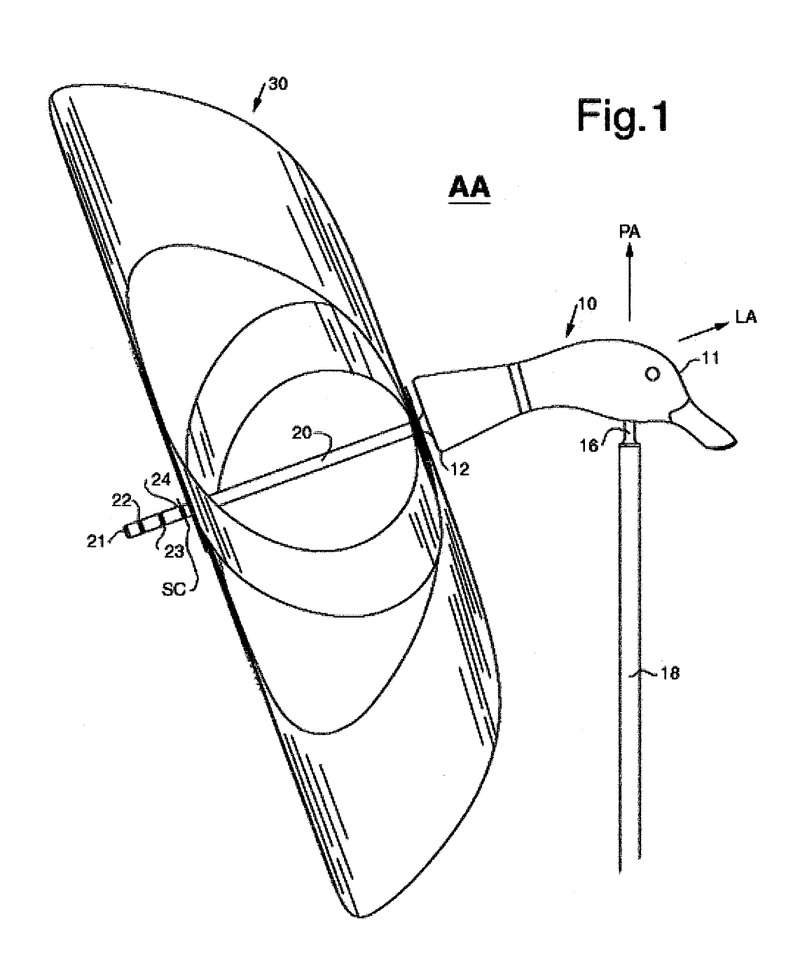

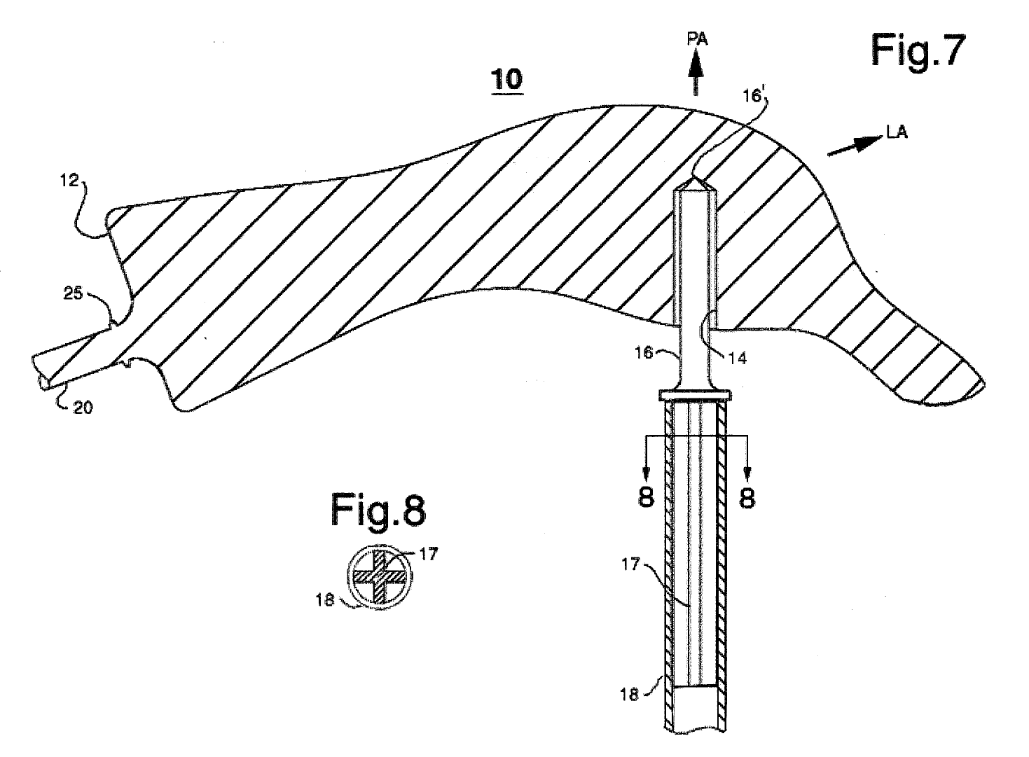

FIG. 1 shows a side view of a dynamic wind powered decoy AA comprising a body portion 10, rod means 20 and a wing assembly 30. The body has a longitudinal axis LA, a front or head end 11 and a back, rear or aft end 12. The rod means 20, in the preferred embodiment, is integral with the body member (see FIG. 7) and extends longitudinally from the body member 10 a preselected distance so as to provide a mounting means for the wing assembly 30. The body member and the integral rod means may advantageously be made using well-known plastic injection molding processes. A preferred plastic material is high-density polyethylene. However, if desired, the rod means may be a separate component (and a different material such as an aluminum or other metal rod) which is connected to the body member using well-known procedures such as the body member having a bore for receiving the rod means.

The body member 10 is shown in the preferred shape of a duck or other waterfowl such as a goose, but other body configurations may be utilized within the scope of the invention.

The body member 10 includes pivot means in the form of a bore 14 (see FIG. 7) which defines a pivot axis PA which is at a preselected angle with respect to the longitudinal axis LA (see both FIGS. 1 & 7).

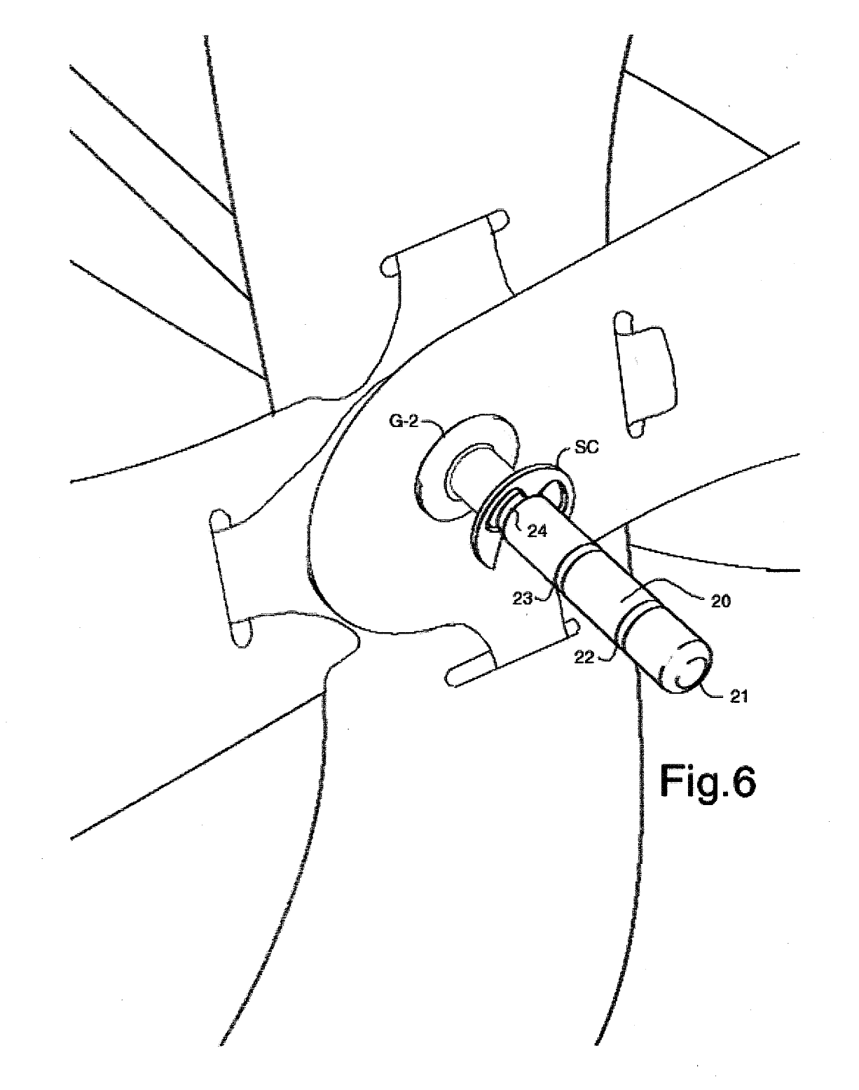

The rod means 20 includes a shoulder or the like 25 adjacent the end 12 of the body member, shoulder 25 functioning to provide a forward end stop for the wing assembly 30. The aft end 21 of the rod means 20 is shown in FIG. 6. Three circumferential grooves, notches (or equivalent) 22, 23, & 24 are provided in the rod means 20 adjacent to end 21 but longitudinally spaced from one another as is shown in FIG. 6; they are available selectively for co-action with a retainer means such as a snap clip SC for retaining the aft end of the wing assembly on the rod means.

The wing assembly 30 is comprised of a plurality of individual, substantially identical wing elements. The preferred embodiment of the invention uses four elements 31, 32, 33 & 34, but a lesser or greater number of elements may be used.

The wing elements are fabricated (preferably die cut) from flat, thin flexible material; a preferred material is high-density polyethylene having a thickness of 0.020 inch.

Sheet stock of this material is available from Industrial Custom Products and other suppliers. This material has the additional property of being smooth and thus slippery which is important to the efficient implementation of the wing assembly as will be described below.

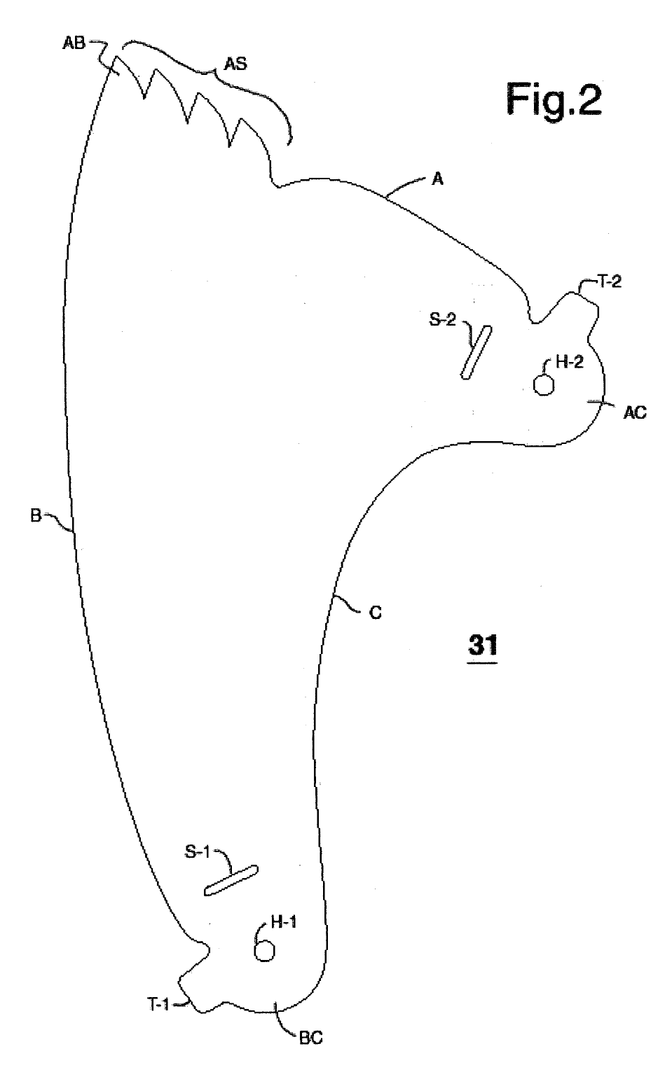

The details of the wing element 31 are shown in FIG. 2; it will be understood that the identifiers for the details of element 31 also apply to the other elements.

Each wing element has a generally three-sided configuration with three sides A, B & C defining three corners AB, AC & BC. Side A, adjacent corner AB, has a scalloped edge AS.

A pair of holes H-1 & H-2 through each element is respectively adjacent corners BC & AC. A pair of slots S-1 & S-2 are respectively adjacent holes H-1 & H-2, and a pair of outwardly extending tabs T-1 and T-2 are respectively adjacent holes H-1 & H-2. The slots and tabs are sized so that the tabs may be fitted into the slots. The holes are sized so that they may rotatably receive the rod means.

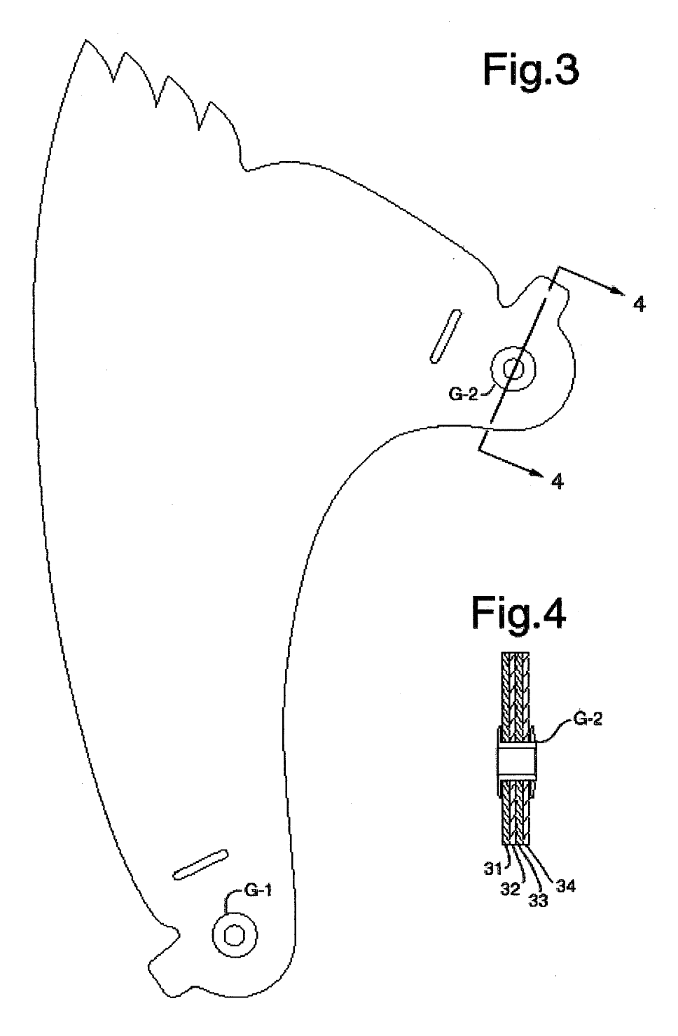

FIG. 3 shows, in plan view, an assembly of the four elements 31-34, the elements being in side-by-side, (initial) congruent relationship, and maintained in an abutting relationship by a pair of identical grommet-like means G-1 & G-2 which are multifunctional. As shown in FIG. 4, the grommet G-2 has a length preselected so that it may hold together the elements 31-34 in abutting, but rotational, relationship. Also, each of the grommets has a central bore, the diameter of which is selected so that it may rotatably receive the rod means.

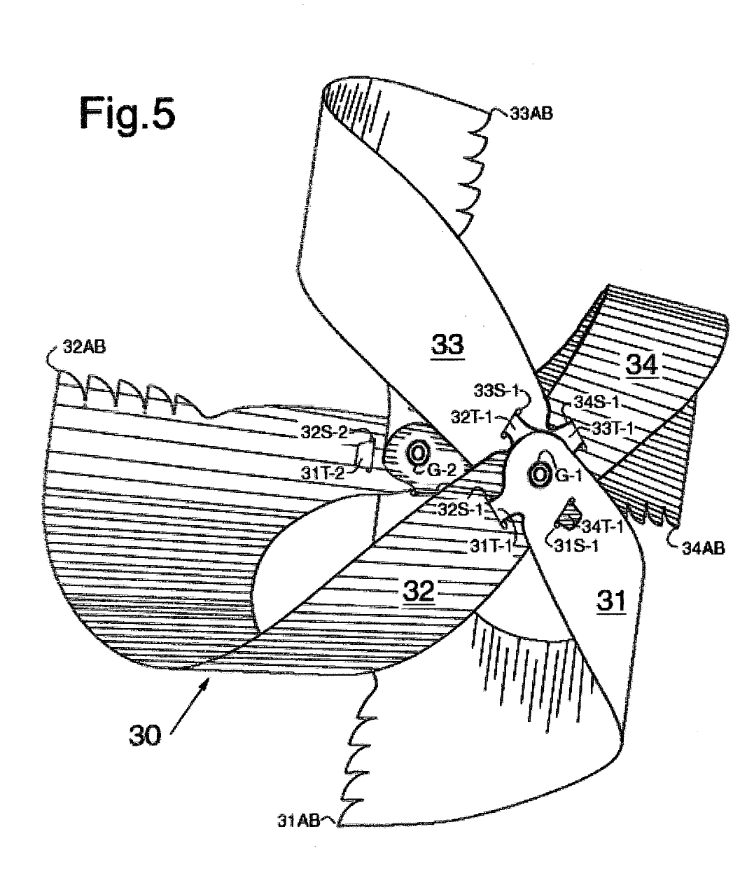

It is important to understand, while the individual elements are held in abutting relationship as aforesaid, the elements are free to be manually rotated about the grommet bore axes relative to the other elements, all the while being prevented by the grommets from any relative motion in the direction of the grommet bore axes. As indicated, the preferred high density polyethylene material of the elements is inherently slippery and the axial length of the grommets are selected so as to facilitate the assembled elements as shown in FIGS. 3 & 4 to be manually arranged into the configuration shown in FIGS. 1, 5 & 6. For a wing assembly having four elements, the elements are arranged at 90-degree intervals about the longitudinal axis.

One of the advantages of the invention is that the decoy can be economically and attractively packaged at the manufacturing facility with the wing elements 31-34 being flat and connected with the grommets as is depicted in FIGS. 3 & 4. The ultimate user of the decoy arranges the wing assembly to represent that shown in FIG. 5 by sequentially inserting a tab of one element into a slot of the next adjacent element. Thus, in FIG. 5, the tab 31T-1 of element 31 is fitted into slot 32S-1 of element 32; the tab 32T-1 in inserted into slot 33S-1; the tab 33T-1 is inserted into slot 34S-1; and the tab 34T-1 is inserted into slot 31 S-1. Concurrently, the other sets of tabs and slots, e.g., 31 T-2 & 31 S-2 are positioned in the same manner to yield the assembly shown, as aforesaid, in FIG. 5.

The aforesaid user performed arrangement transforms the elements from a basically two dimension assembly of FIGS. 3 & 4 into a three dimension curved element wing assembly of FIG. 5 having high aerodynamic efficiencies.

The wing assembly of FIG. 5 may then be mounted on the rod means 20, the rod means being rotatably received by grommets G-1 & G-2, the forward grommet G-1 being abutted against the shoulder 25 and the aft grommet G-2 abutting retainer SC as shown in FIG. 6.

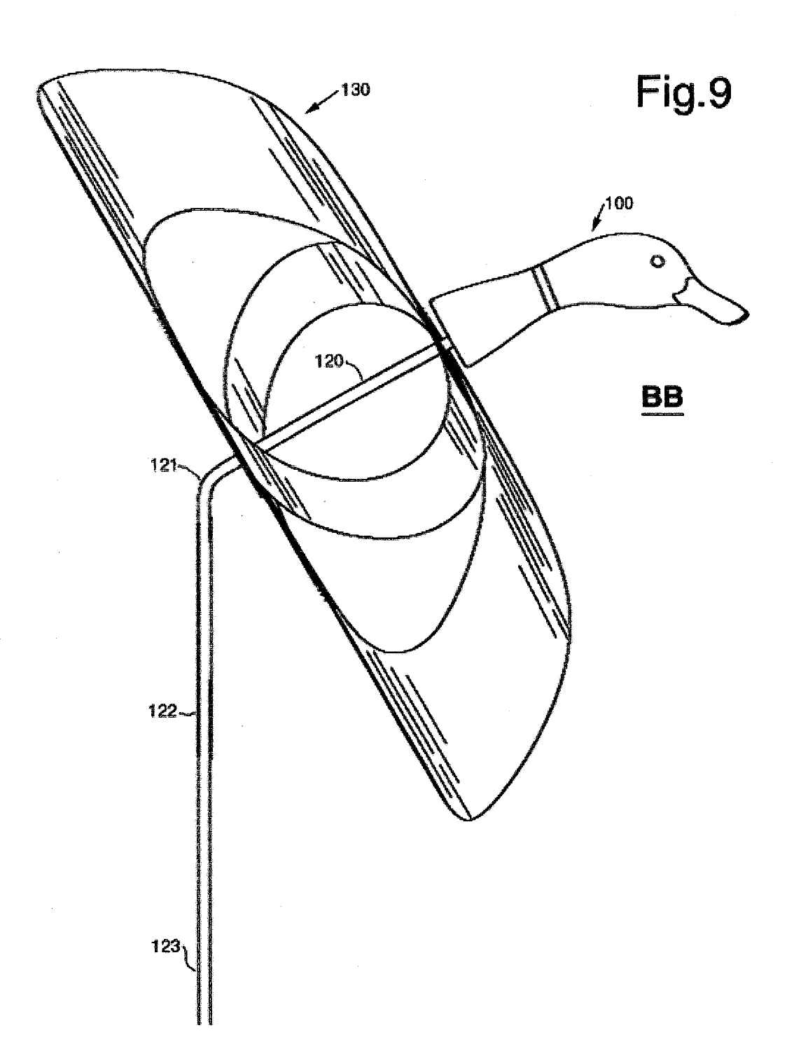

To operationally use the decoy AA, a support means 16/17 & 18 (or equivalent) is required. As shown in FIGS. 1 & 7 the support means 16 is a short shaft of a diameter less that that of the bore 14 in the body member, the top 16′ of the shaft 16 being pointed so as to provide a low friction pivotal support of the decoy. The shaft 16 has an integral shank 17 having a cruciform cross section as is shown in FIG. 8 and which is sized to fit within the bore of a pipe-like member 18 adapted to be set in the ground or other equivalent base.

The decoy then utilizes the wind power to provide two important dynamic actions: to (1) rotate the wing assembly about the rod assembly and (2) rotate the entire decoy about the pivot axis to a heading whereat the wind direction vector and the longitudinal axis are co-planar, i.e., the head of the decoy will be headed into the wind. The rotation of the decoy about the pivot axis is typically the first of the actions and, as the head of the decoy begins to head into the wind, then the wing assembly will react to the wind and begin to rotate about the rod means. When the wind direction vector is co-planar with the longitudinal axis, then the wing assembly angular velocity (rotational speed) is maximized. It will be understood that the wing assembly, being positioned aft of the body member on the rod means, and at rest or while rotating, functions similar to a tail on a weather vane causing the vane to head into the wind. Those skilled in the art will understand that the optimum longitudinal positioning of the pivot axis PA, the location of the bore 14 may be determined by well-known engineering principles.

The decoy's visual impact and reach on lurking ducks or other waterfowl can be significantly increased by having one half of the wing elements of a light coloration, e.g., white, and alternate wing elements of a dark coloration, e.g., black as is shown in FIG. 5. Thus, when the wing assembly is rotating, the alternate coloration produces a flash-type visual effect which will draw the waterfowl in from much greater distances as compared to the shorter reach of a static decoy.

The aerodynamic design of the decoy, i.e., the head or body member and the wing assembly in combination with low friction journaling of the wing assembly on the rod means and low friction rotational support of the decoy about the pivot axis results in the decoy being able to become dynamic even in a slight breeze. Thus, the decoy will follow the wind vector and the wing assembly will rotate. As will be understood, the wing angular velocity will increase as a function of the wind velocity. The response (angular velocity) of the wing assembly in response to the wind velocity may be varied by changing the position of the retainer snap clip SC on rod means 20 from one of the grooves 22-24 to another.

FIG. 9 shows a modification of the preferred embodiment. Instead of the decoy being pivotally supported to rotate to head into the wind as aforesaid, the decoy of FIG. 9 has a rod means 120 connected to a body member 100 and rotatably supporting a wing assembly 130. The rod means 120 has, via a bend 121, an extension 122 which may be inserted into the ground or equivalent; thus, this embodiment would be set initially to face the wind, but would not have the automatic tracking of the wind, as is the function of the preferred embodiment.

While the preferred embodiment of the invention has been illustrated and described, it will be understood that variations may be made by those skilled in the art without departing from the inventive concept. Accordingly, the invention is to be limited only by the scope of the following claims.

We claim:

1. A dynamic wind powered decoy comprising:
a. a body member having a longitudinal axis, a head end and a back end;
b. rod means connected to said back end of said body member and extending longitudinally away from said back end of said body member; and
c. a wing assembly rotatably mounted on said rod means for rotation about said longitudinal axis.

2. The decoy of claim 1 wherein said wing assembly comprises a plurality of separate elements, each of said elements being fabricated from flat, thin, and flexible material.

3. The decoy of claim 2 wherein said elements have a generally three sided configuration with three sides and three corners and each of said elements has (i) first and second holes respectively located proximate to two of said corners, (ii) a pair of slots positioned respectively adjacent to said first and second holes, and (iii) a pair of outwardly extending tabs positioned respectively adjacent to said first and second holes.

4. The decoy of claim 3 wherein said slots and tabs are sized so that said tabs may be fitted into said slots and wherein said holes are sized to rotatably receive said rod means.

5. The decoy of claim 1 wherein said rod means is integral with said body member.

6. The decoy of claim 1 wherein said body member is shaped like the head and neck of a waterfowl.

7. The decoy of claim 1, further including pivot means in said body member, said pivot means defining a decoy pivot axis at a preselected angle with said longitudinal axis, said decoy being characterized, when supported by means co-acting with said pivot means in a wind having a direction vector and a preselected wind velocity, by (i) said wing assembly rotating about said rod means and said longitudinal axis and with respect with said body member, and (ii) said decoy rotating about said decoy pivot axis to a position where said longitudinal axis and said wind direction vector are co-planar.

8. The decoy of claim 4, further including pivot means in said body member, said pivot means defining a decoy pivot axis at a preselected angle with said longitudinal axis, said decoy being characterized, when supported by means co-acting with said pivot means in a wind having a direction vector and a preselected wind velocity, by (i) said wing assembly rotating about said rod means and said longitudinal axis and with respect with said body member, and (ii) said decoy rotating about said decoy pivot axis to a position where said longitudinal axis and said wind vector are co-planar.

9. The decoy of claim 8 wherein said wing assembly is further characterized by comprising four of said elements in side-by-side relationship and first and second grommet-like means respectively rotatably connected through said first and second holes of said four of said elements, said four of said elements being positioned so that (i) said tabs of a first of said four of said elements are fitted into said slots of a second of said four of said elements, (ii) said tabs of said second of said elements are fitted into said slots of a third of said four of said elements, (iii) said tabs of said third of said elements are fitted into said slots of a fourth of said four of said elements, and (iv) said tabs of said fourth of said elements are fitted into said slots of said first of said elements.

10. The decoy of claim 9 wherein said grommet like means are rotatably positioned on said rod means with the first grommet-like means being positioned proximate to said back end of said body member and the second grommet-like means being longitudinally spaced along said rod means away from said first grommet-like means, each of said elements being constrained, by said grommet-like means, into a curved, three-dimensional shape, whereby said four of said elements collectively may interact with said preselected wind to rotate in unison about said longitudinal axis.

11. The decoy of claim 10, including shoulder means on said rod means adjacent to said back end of said body member to provide a longitudinal stop means for said first grommet-like means.

12. The decoy of claim 10, including retainer means selectively connectable to said rod means to provide means for retaining said second grommet-like means on said rod means.

13. The decoy of claim 12, including means for varying the longitudinal point of attachment of said retainer means to said rod means.

14. A wing assembly for a dynamic decoy, said assembly comprising (A) a plurality of elements, each of said elements (i) being fabricated from flat, thin and flexible material, (ii) having a generally three sided configuration with three sides and three corners, and (iii) having (a) first and second holes respectively located proximate to two of said corners, (b) a pair of slots positioned respectively adjacent to said first and second holes, and (c) a pair of outwardly extending tabs positioned respectively adjacent to said first and second holes, and (B) first and second grommet-like means respectively rotatably connected through said first and second holes of said plurality of elements.

15. The wing assembly of claim 14 in combination with rod means having a longitudinal axis and wherein said first and second grommet-like means are rotatably mounted on said rod means whereby said elements may rotate relative to said rod means about said longitudinal axis.

16. The wing assembly of claim 15 wherein said tabs of each of said elements are fitted into said slots of another one of said elements.

17. The wing assembly and rod means of claim 16, in combination with a body member connected to said rod means, said body member including pivot means defining a pivot axis having a preselected angle with said longitudinal axis, whereby, when said body member is supported by means co-acting with said pivot means in a wind having a direction vector and a preselected wind velocity, said wing assembly will rotate about said longitudinal axis relative to said rod means and said body will rotate about said pivot axis to a position where said longitudinal axis and said wind vector are co-planar and said body is headed into the wind.

18. The decoy of claim 9 wherein said elements are alternately of dark and light coloration.

19. The wing assembly of claim 17 wherein said elements are alternately of dark and light coloration.
